(19) United States
(12) Patent Application Publication
(10) Pub. No.: US 2015/0116058 A1
(43) Pub. Date: Apr. 30, 2015

(54) RADIO FREQUENCY (RF) CAVITY FILTER INCLUDING TUNING BOLT HOLDING MEMBER AND SAID TUNING BOLT HOLDING MEMBER

(71) Applicant: Electronics and Telecommunications Research Institute, Daejeon (KR)

(72) Inventors: Hong Yeol LEE, Cheongju-Si (KR); Man Seok UHM, Daejeon (KR); Chang Soo KWAK, Daejeon (KR); So Hyeun YUN, Daejeon (KR); In Bok YOM, Daejeon (KR)

(73) Assignee: Electronics and Telecommunications Research Institute, Daejeon (KR)

(21) Appl. No.: 14/524,368

(22) Filed: Oct. 27, 2014

(30) Foreign Application Priority Data
Oct. 30, 2013 (KR) 10-2013-0130058

(51) Int. Cl. H01P 1/20

(52) U.S. Cl. CPC H01P 1/2002; H01P 7/06
USPC 333/202; 333/235

(57) ABSTRACT

Provided is a radio frequency (RF) cavity filter including a tuning bolt holding member, the RF cavity filter including a top block, a bottom block to form a cavity along with the top block, a resonator disposed in the cavity, a tuning bolt to penetrate through the top block, and a tuning bolt holding member disposed to be in contact with one end of the tuning bolt to hold the tuning bolt, which may fix a position of the tuning bolt.

### CROSS-REFERENCE TO RELATED APPLICATION

This application claims the benefit of Korean Patent Application No. 10-2013-0130058, filed on Oct. 30, 2013, in the Korean Intellectual Property Office, the disclosure of which is incorporated herein by reference.

### BACKGROUND

1. Field of the Invention

The present invention relates to a radio frequency (RF) cavity filter including a tuning bolt holding member, and the tuning bolt holding member.

2. Description of the Related Art

In satellite communications, channels are allocated so that a frequency band may have a narrow guard band for efficient use of limited frequency resources. Thus, a radio frequency (RF) channel filter with an excellent frequency selectivity is needed. In addition, since a satellite payload is becoming highly precise and miniaturized, small-sized or light-weighted components are required.

To reduce a size and a volume of the channel filter, a dual mode resonator filter including two resonant modes in a single cavity is applied. For further miniaturization, a channel filter using a dielectric resonator having a low dielectric loss and a high quality (Q) factor is being developed. In general, in a case of a dielectric resonator being used, a size of the channel filter may be reduced at a rate of 1/\sqrt{∈ᵣ}, when compared to a case in which a dielectric resonator is not used. In this example, ∈ᵣ denotes a dielectric constant of a dielectric substance. In addition, due to saturation of frequency resources in satellite communications, a development of a Ka band corresponding to a frequency band of about 30 gigahertz (GHz) is being actively pursued, and a size of a half-wave resonator may decrease in inverse proportion to a frequency.

A filter is a device that allows signals in a predetermined frequency band, among input frequency signals, to pass therethrough. A channel filter provided in a satellite may be designed to have a high performance in blocking out-of-band signals and an excellent in-band flatness. To select a frequency in a predetermined band or adjust a band in the channel filter, a resonant frequency of a resonator may be tuned or a level of coupling between resonators may be adjusted by a tuning bolt. The tuning bolt may be disposed in a filter block. When the tuning bolt is turned to be inserted into an internal portion of a resonator, an electric field distribution in the resonator may be changed, leading to a change in an impedance. Thus, the resonant frequency may change or the level of coupling between the resonators may change.

However, as there may be an infinitesimal gap between a thread provided in the filter block and the tuning bolt, the tuning bolt may not be completely fixed to the filter block. Thus, an oscillation or impact may cause a vibration, and the impedance may be changed. In addition, the infinitesimal gap may preclude an electrical contact between the tuning bolt and the filter block.

To resolve such issues, as to a tuning bolt holding method, U.S. Registered Pat. No. 4,035,749 is directed to a structure in which a chuck bolt is fixed to a resonator, and a tuning bolt is received in the chuck bolt along a thread provided on an inner side of the chuck bolt.

### SUMMARY

An aspect of the present invention provides a radio frequency (RF) cavity filter including a tuning bolt holding member that may be used to select a frequency in a predetermined band or adjust a passband in a channel filter.

Another aspect of the present invention also provides a tuning bolt holding member that may be used to completely hold a tuning bolt so that the tuning bolt may not move in an RF filter, thereby preventing a resonant frequency or a level of coupling between resonators from being changed.

According to an aspect of the present invention, there is provided an RF cavity filter including a top block, a bottom block to form a cavity along with the top block, a resonator disposed in the cavity, a tuning bolt to penetrate through the top block, and a tuning bolt holding member disposed to be in contact with one end of the tuning bolt to hold the tuning bolt. The tuning bolt holding member may fix a position of the tuning bolt.

The cavity may be in a vacuum state, or be filled with a gas.

The RF cavity filter may further include a resonator fixing member fixed to the bottom block to fix the resonator.

The tuning bolt may move relative to the top block in a longitudinal direction of the tuning bolt while a thread of a portion of the top block through which the tuning bolt penetrates is being engaged with a thread of the tuning bolt.

The tuning bolt may include an adjustment recess disposed on a head of the tuning bolt.

The tuning bolt holding member may be adjacent to the tuning bolt in a direction perpendicular to a longitudinal direction of the tuning bolt.

The tuning bolt holding member may include a holding portion disposed to be in contact with one end of the tuning bolt, and a bolt portion.

The holding portion may include an elastic material.

The bolt portion may include an adjustment recess disposed on a head of the bolt portion.

According to another aspect of the present invention, there is also provided an RF cavity filter including a housing to form a cavity, a resonator disposed in the cavity, a tuning bolt to penetrate through the housing, and a tuning bolt holding member disposed to be in contact with one end of the tuning bolt to hold the tuning bolt. The tuning bolt holding member may fix a position of the tuning bolt.

The cavity may be in a vacuum state, or be filled with a gas.

The RF cavity filter may further include a resonator fixing member fixed to one inner surface of the housing to fix the resonator.

The tuning bolt may move relative to the housing in a longitudinal direction of the tuning bolt while a thread of a portion of the housing through which the tuning bolt penetrates is being engaged with a thread of the tuning bolt.

The tuning bolt may include an adjustment recess disposed on a head of the tuning to bolt.

The tuning bolt holding member may be adjacent to the tuning bolt in a direction perpendicular to a longitudinal direction of the tuning bolt.

The tuning bolt holding member may include a holding portion disposed to be in contact with one end of the tuning bolt, and a bolt portion.

According to still another aspect of the present invention, there is also provided a tuning bolt holding member in contact with one end of a tuning bolt to hold the tuning bolt, in an RF cavity filter including a top block, a bottom block to form a cavity along with the top block, a resonator disposed in the cavity, and the tuning bolt to penetrate through the top block.

The tuning bolt holding member may penetrate through the top block, may be adjacent to the tuning bolt in a direction perpendicular to a longitudinal direction of the tuning bolt, and may move relative to the top block.

The tuning bolt holding member may include a holding portion disposed to be in contact with one end of the tuning bolt, and a bolt portion.

The bolt portion may include an adjustment recess disposed on a head of the bolt portion.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a cross-sectional view and a perspective view of a radio frequency (RF) cavity filter according to a prior art;

FIG. 2 illustrates a cross-sectional view of an RF cavity filter including a top block and a bottom block according to an embodiment of the present invention;

FIG. 3 illustrates a cross-sectional view of an RF cavity filter including a housing to according to an embodiment of the present invention; and

FIG. 4 illustrates an enlarged cross-sectional view of a tuning bolt holding member according to an embodiment of the present invention.

### DETAILED DESCRIPTION

Hereinafter, configurations and applications according to exemplary embodiments of the present invention will be described in detail with reference to the accompanying drawings. The following descriptions provide one of various aspects of the present invention and constitute part of the detailed description on the present invention.

However, in describing the exemplary embodiments of the present invention, detailed descriptions on generally known functions or configurations will be omitted for conciseness. In addition, the same element is used for elements performing like functions and actions throughout the drawings.

Throughout the specification, the term “include” is intended to indicate that characteristics, numbers, steps, operations, components, elements, etc. disclosed in the specification or combinations thereof exist. As such, the term “include” should be understood that there are additional possibilities of one or more other characteristics, numbers, steps, operations, components, elements or combinations thereof.

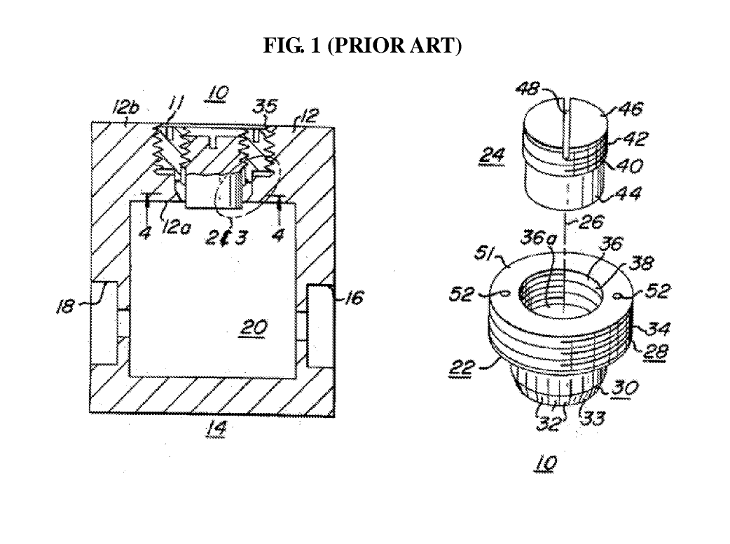

FIG. 1 illustrates a cross-sectional view and a perspective view of a radio frequency (RF) cavity filter according to a prior art.

Referring to FIG. 1, a tuning bolt 24 may be turned to move in a longitudinal direction while being engaged with a screw of a chuck bolt 22. In this structure, interference with the chuck bolt 22 may occur in a case in which a distance between cavities is relatively short. In addition, there may be an infinitesimal gap between a thread provided on an inner side of the chuck bolt 22 and the tuning bolt 24. Thus, the structure may be shaken by an oscillation.

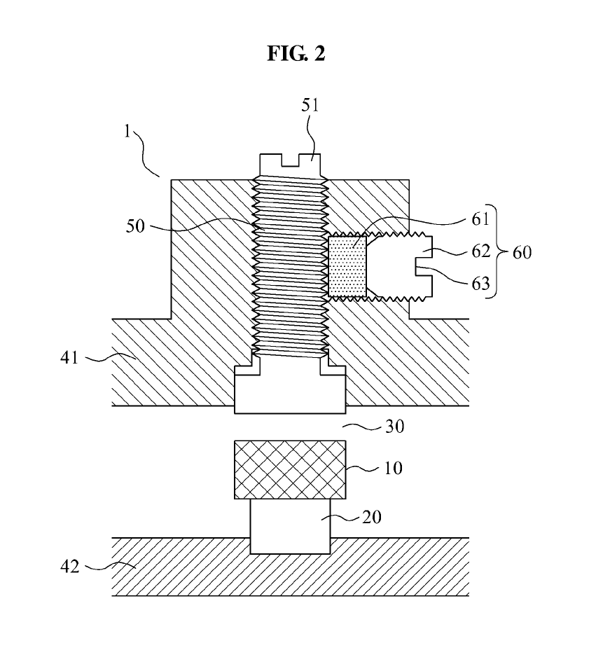

FIG. 2 illustrates a cross-sectional view of an RF cavity filter 1 including a top block 41 and a bottom block 42 according to an embodiment of the present invention.

Referring to FIG. 2, the top block 41 and the bottom block 42 may constitute a basic structure of the RF cavity filter 1. The top block 41 and the bottom block 42 may form a cavity 30, which is an empty space, rather than completely filling an inner space of the RF cavity filter 1. A resonator 10 may be disposed in the cavity 30. The RF cavity filter 1 may include a tuning bolt 50 configured to penetrate through the top block 41, and a tuning bolt holding member 60 disposed to be in contact with one end of the tuning bolt 50 to hold the tuning bolt 50. The tuning bolt holding member 60 may fix a position of the tuning bolt 50.

As illustrated in FIG. 2, a portion of the top block 41 through which the tuning bolt 50 penetrates may protrude in an axial direction of the top block 41 to increase a supporting force with respect to the tuning bolt 50. When a portion of the top block 41 is configured to protrude, the greater an area of a portion that supports the tuning bolt 50 in the top block 41, the greater a supporting force.

The cavity 30 may be in a vacuum state, or be filled with a gas. The gas may include general air. In addition, to increase a lifespan of the cavity 30, inert gases with a relatively low reactivity and a relatively high stability, for example, argon (Ar) gas, and neon (Ne) gas, may be used. By filling the cavity 30 with an excessive amount of gas, the tuning bolt 50 may be easily driven in or out of the RF cavity filter 1.

The RF cavity filter 1 may further include a resonator fixing member 20 fixed to the bottom block 42 to fix the resonator 10. When the resonator 10 is disposed close to the tuning bolt 50, an oscillation of the resonator 10 may minutely change the position of the tuning bolt 50. Thus, the resonator fixing member 20 may need to be fixed to the bottom block 42.

The tuning bolt 50 may penetrate through the top block 41, and may cause a change in a resonant frequency of the RF cavity filter 1. The tuning bolt 50 may be provided in a form of a bolt including an externally-threaded screw to adjust the position of the tuning bolt 50. The portion of the top block 41 through which the tuning bolt 50 penetrates may include an internally-threaded screw having a size sufficient to receive the externally-threaded screw of the tuning bolt 50.

To adjust the resonant frequency of the RF cavity filter 1, the tuning bolt 50 may be turned to be driven in or out of the RF cavity filter 1. While the thread of the portion of the top block 41 through which the tuning bolt 50 penetrates is being engaged with the thread of the tuning bolt 50, the tuning bolt 50 may move relative to the top block 41 in a longitudinal direction of the tuning bolt 50.

The tuning bolt 50 may include an adjustment recess 51 disposed on a head of the tuning bolt 50. For example, the adjustment recess 51 may include a slotted adjustment recess that traverses a center of the head of the tuning bolt 50 so that the tuning bolt 50 may be adjusted by a flat-head screwdriver. In addition, a cross adjustment recess may be included on the head of the tuning bolt 50 so that the tuning bolt 50 may be adjusted by a Phillips-head screwdriver. The adjustment recess 51 may be provided in any shape of recess so that the tuning bolt 50 may be driven by any corresponding shape of external tool.

The tuning bolt holding member 60 may be disposed adjacent to the tuning bolt 50 in a direction perpendicular to the longitudinal direction of the tuning bolt 50. The tuning bolt holding member 60 may physically press the tuning bolt 50 so that the tuning bolt 50 may be held. When the tuning bolt 50 is twisted, a force may be applied in the longitudinal direction of the tuning bolt 50, rather than the direction perpendicular to the longitudinal direction of the tuning bolt 50, leading to a change in the delicately adjusted position of the tuning bolt 50. Accordingly, the top block 41 may need to be processed precisely so that the tuning bolt holding member 60 may be disposed in the direction perpendicular to the longitudinal direction of the tuning bolt 50.

The RF cavity filter 1 may be provided in any shape, for example, a circular shape, a rectangular shape, and a polygonal shape, based on a plan view viewed from above the RF cavity filter 1. In a case in which the tuning bolt holding member 20 is externally adjustable based on an axial direction of the tuning bolt 50, the tuning bolt holding member 60 may be disposed at any position in a 360-degree rotation.

The tuning bolt holding member 60 may include a holding portion 61 disposed to be in contact with one end of the tuning bolt 50, and a bolt portion 62. The holding portion 61 is a portion directly touching the tuning bolt 50, and may include an elastic material to increase a contact level. The elastic material may include a plastic material, for example, Teflon, an acetal resin, and a polycarbonate (PC). Depending on a case, the elastic material may include a metallic material or a nonmetallic material of which a contact level with respect to the tuning bolt 50 is easily adjustable.

The bolt portion 62 may include an adjustment recess 63 disposed on a head of the bolt portion 62. For example, the adjustment recess 63 may include a slotted adjustment recess that traverses a center of the head of the bolt portion 62 so that the bolt portion 62 may be adjusted by a flat-head screwdriver. In addition, a cross adjustment recess may be included on the head of the bolt portion 62 so that the bolt portion 62 may be adjusted by a Phillips-head screwdriver. The adjustment recess 63 may be provided in any shape of recess so that the bolt portion 62 may be driven by any corresponding shape of external tool.

There may be an infinitesimal gap between a thread provided in the portion of the top block 41 through which the turning bolt 50 penetrates and a thread of the tuning bolt 50. When an oxide is created in the gap between the threads, a passive inter-modulation distortion (PIMD) characteristic may deteriorate, and a stable contact therebetween may be disturbed. In addition, an oscillation may cause a movement, and thus the resonant frequency may be changed.

The tuning bolt holding member 60 may be used to dispose the tuning bolt 50 to be in close contact with the top block 41, whereby the gap between the threads may be minimized As a contact area increases, a structure in which a stable contact therebetween is enabled and thus, an external oscillation does not produce a movement may be implemented. A contact level of the tuning bolt 50 with respect to the top block 41 may be adjusted based on a level of tightening the tuning bolt holding member 60.

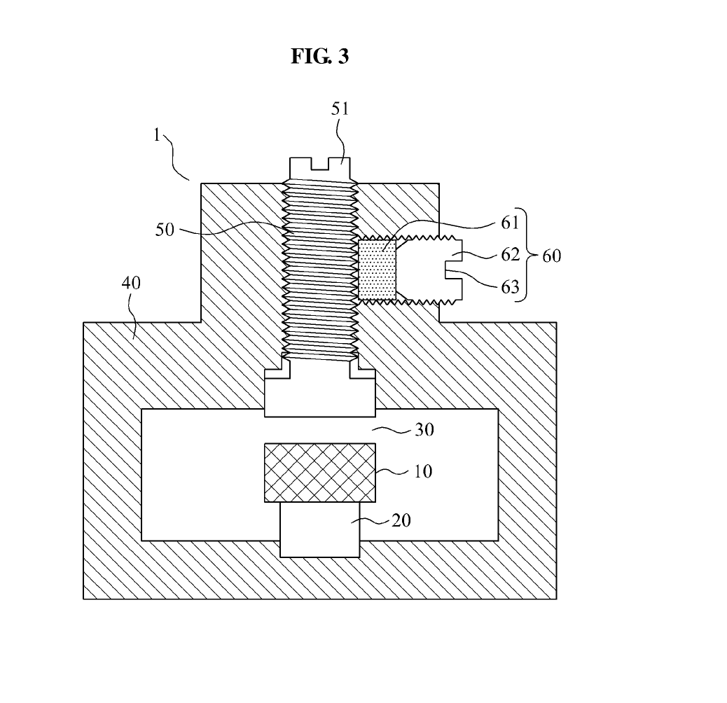

FIG. 3 illustrates a cross-sectional view of an RF cavity filter 1 including a housing 40 according to an embodiment of the present invention.

Referring to FIG. 3, the RF cavity filter 1 may include the housing 40 to form a cavity 30, a resonator 10 disposed in the cavity 30, a tuning bolt 50 configured to penetrate through the housing 40, and a tuning bolt holding member 60 disposed to be in contact with one end of the tuning bolt 50 to hold the tuning bolt 50. The tuning bolt holding member 60 may fix a position of the tuning bolt 50.

As illustrated in FIG. 3, a portion of the housing 40 through which the tuning bolt 50 penetrates may protrude in an axial direction of the tuning bolt 50 to increase a supporting force with respect to the tuning bolt 50. When a portion of the housing 40 is configured to protrude, the greater an area of a portion that supports the tuning bolt 50 in the housing 40, the greater the supporting force.

The cavity 30 may be in a vacuum state, or be filled with a gas. The gas may include general air. In addition, to increase a lifespan of the cavity 30, inert gases with a relatively low reactivity and a relatively high stability, for example, Ar gas, and Ne gas, may be used. By filling the cavity 30 with an excessive amount of gas, the tuning bolt 50 may be easily driven in or out of the RF cavity filter 1.

The tuning bolt 50 may penetrate through the housing 40, and may cause a change in a resonant frequency of the RF cavity filter 1. The tuning bolt 50 may be provided in a form of a bolt including an externally-threaded screw to adjust the position of the tuning bolt 50. The portion of the housing 40 through which the tuning bolt 50 penetrates may include an internally-threaded screw having a size sufficient to receive the externally-threaded screw of the tuning bolt 50.

To adjust the resonant frequency of the RF cavity filter 1, the tuning bolt 50 may be turned to be driven in or out of the RF cavity filter 1. While the thread of the portion of the housing 40 through which the tuning bolt 50 penetrates is being engaged with the thread of the tuning bolt 50, the tuning bolt 50 may move relative to the housing 40 in a longitudinal direction of the tuning bolt 50.

The tuning bolt holding member 60 may be disposed adjacent to the tuning bolt 50 in a direction perpendicular to a longitudinal direction of the tuning bolt 50. The tuning bolt holding member 60 may physically press the tuning bolt 50 so that the tuning bolt 50 may be held. When the tuning bolt 50 is twisted, a force may be applied in the longitudinal direction of the tuning bolt 50, rather than the direction perpendicular to the longitudinal direction of the tuning bolt 50, leading to a change in the delicately adjusted position of the tuning bolt 50. Accordingly, the housing 40 may need to be processed precisely so that the tuning bolt holding member 60 may be disposed in the direction perpendicular to the longitudinal direction of the tuning bolt 50.

The tuning bolt holding member 60 may include a holding portion 61 disposed to be in contact with one end of the tuning bolt 50, and a bolt portion 62. The holding portion 61 is a portion directly touching the tuning bolt 50, and may include an elastic material to increase a contact level. The elastic material may include a plastic material, for example, Teflon, an acetal resin, and a PC. Depending on a case, the elastic material may include a metallic material or a nonmetallic material of which a contact level with respect to the tuning bolt 50 is easily adjustable.

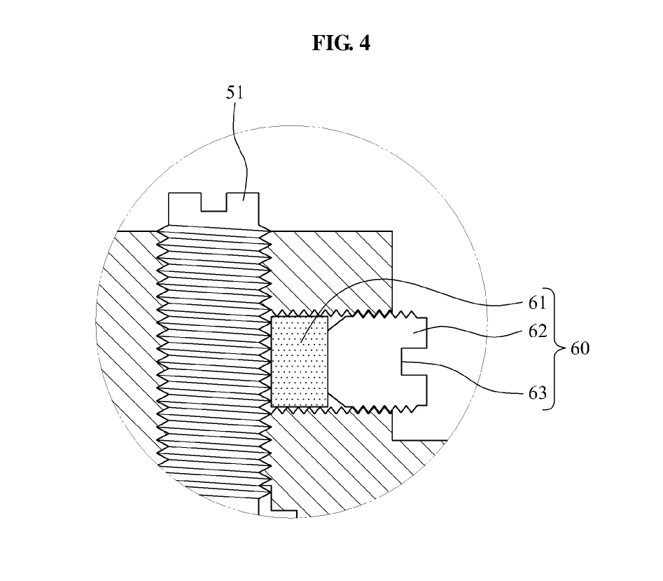

FIG. 4 illustrates an enlarged cross-sectional view of a tuning bolt holding member 60 according to an embodiment of the present invention.

Referring to FIG. 4, the tuning bolt holding member 60 may be disposed to be in contact with one end of a tuning bolt 50 to hold the tuning bolt 50 in an RF cavity filter 10 including a top block 41, a bottom block 42 to form a cavity 30 along with the top block 41, a resonator 10 disposed in the cavity 30, and the tuning bolt 50 configured to penetrate the top block 41.

The tuning bolt holding member 60 may include a holding portion 61 disposed to be in contact with one end of the tuning bolt 50, and a bolt portion 62. The holding portion 61 is a portion directly touching the tuning bolt 50, and may include an elastic material to increase a contact level. The elastic material may include a plastic material, for example, Teflon, an acetal resin, and a PC. Depending on a case, the elastic material may include a metallic material or a nonmetallic material of which a contact level with respect to the tuning bolt 50 is easily adjustable.

The bolt portion 62 may include an adjustment recess 63 disposed on a head of the bolt portion 62. For example, the adjustment recess 63 may include a slotted adjustment recess that traverses a center of the head of the bolt portion 62 so that the bolt portion 62 may be adjusted by a flat-head screwdriver. In addition, a cross adjustment recess may be included on the head of the bolt portion 62 so that the bolt portion 62 may be adjusted by a Phillips-head screwdriver. The adjustment recess 63 may be provided in any shape of recess so that the bolt portion 62 may be driven by any corresponding shape of external tool.

By tightly holding the tuning bolt 50 using the tuning bolt holding member 60 even after tuning is performed, a contact between the top block 41 and the tuning bolt 50 may be improved, and a change in an impedance may be prevented. Although mutual interference between nuts used to hold a tuning bolt or a contact block occurs and the nuts are unavailable since a distance between cavities is relatively short, similar to a case in which a dielectric resonator is used at a relatively high frequency, for example, in a Ka band, the tuning bolt may be held tightly.

According to an embodiment, an RF cavity filter including a tuning bolt holding member may be used to select a frequency in a predetermined band or adjust a passband in a to channel filter.

According to another embodiment, a tuning bolt holding member may be used to completely hold a tuning bolt so that the tuning bolt may not move in an RF filter, thereby preventing a resonant frequency or a level of coupling between resonators from being changed.

While the present invention has been particularly shown and described with reference to exemplary embodiments thereof, it will be understood by those of ordinary skill in the art that various changes in form and details may be made therein without departing from the spirit and scope of the present invention as defined by the following claims.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A radio frequency (RF) cavity filter comprising:
a top block;
a bottom block to form a cavity along with the top block;
a resonator disposed in the cavity;
a tuning bolt to penetrate through the top block; and
a tuning bolt holding member disposed to be in contact with one end of the tuning bolt to hold the tuning bolt,
wherein the tuning bolt holding member fixes a position of the tuning bolt.

2. The RF cavity filter of claim 1, wherein the cavity is in a vacuum state, or is filled with a gas.

3. The RF cavity filter of claim 1, further comprising a resonator fixing member fixed to the bottom block to fix the resonator.

4. The RF cavity filter of claim 1, wherein the tuning bolt moves relative to the top block in a longitudinal direction of the tuning bolt while a thread of a portion of the top block through which the tuning bolt penetrates is being engaged with a thread of the tuning bolt.

5. The RF cavity filter of claim 1, wherein the tuning bolt comprises an adjustment recess disposed on a head of the tuning bolt.

6. The RF cavity filter of claim 1, wherein the tuning bolt holding member is adjacent to the tuning bolt in a direction perpendicular to a longitudinal direction of the tuning bolt.

7. The RF cavity filter of claim 1, wherein the tuning bolt holding member comprises a holding portion disposed to be in contact with one end of the tuning bolt, and a bolt portion.

8. The RF cavity filter of claim 7, wherein the holding portion comprises an elastic material.

9. The RF cavity filter of claim 7, wherein the bolt portion comprises an adjustment recess disposed on a head of the bolt portion.

10. A radio frequency (RF) cavity filter comprising:
a housing to form a cavity;
a resonator disposed in the cavity;
a tuning bolt to penetrate through the housing; and
a tuning bolt holding member disposed to be in contact with one end of the tuning bolt to hold the tuning bolt,
wherein the tuning bolt holding member fixes a position of the tuning bolt.

11. The RF cavity filter of claim 10, wherein the cavity is in a vacuum state, or is filled with a gas.

12. The RF cavity filter of claim 10, further comprising a resonator fixing member fixed to one inner surface of the housing to fix the resonator.

13. The RF cavity filter of claim 10, wherein the tuning bolt moves relative to the housing in a longitudinal direction of the tuning bolt while a thread of a portion of the housing through which the tuning bolt penetrates is being engaged with a thread of the tuning bolt.

14. The RF cavity filter of claim 10, wherein the tuning bolt comprises an adjustment recess disposed on a head of the tuning bolt.

15. The RF cavity filter of claim 10, wherein the tuning bolt holding member is adjacent to the tuning bolt in a direction perpendicular to a longitudinal direction of the tuning bolt.

16. The RF cavity filter of claim 10, wherein the tuning bolt holding member comprises a holding portion disposed to be in contact with one end of the tuning bolt, and a bolt portion.

17. A tuning bolt holding member in contact with one end of a tuning bolt to hold the tuning bolt, in a radio frequency (RF) cavity filter comprising:
a top block;
a bottom block to form a cavity along with the top block;
a resonator disposed in the cavity; and
the tuning bolt to penetrate through the top block.

18. The tuning bolt holding member of claim 17, wherein the tuning bolt holding member penetrates through the top block, is adjacent to the tuning bolt in a direction perpendicular to a longitudinal direction of the tuning bolt, and moves relative to the top block.

19. The tuning bolt holding member of claim 17, comprising a holding portion disposed to be in contact with one end of the tuning bolt, and a bolt portion.

20. The tuning bolt holding member of claim 19, wherein the bolt portion comprises an adjustment recess disposed on a head of the bolt portion.
